(19) United States
(12) Patent Application Publication
(10) Pub. No.: US 2014/0351064 A1
(43) Pub. Date: Nov. 27, 2014

(54) Directional Filmstrip Display in Street View

(71) Applicant: International Business Machines Corporation, Armonk, NY (US)

(72) Inventors: Barry A. Kritt, Raleigh, NC (US); Sarbajit K. Rakshit, Kolkata (IN)

(73) Assignee: International Business Machines Corporation, Armonk, NY (US)

(21) Appl. No.: 13/902,405

(22) Filed: May 24, 2013

(51) Int. Cl. G06K 9/00; G06Q 30/02; G06T 3/40

(52) U.S. Cl. CPC G06K 9/00671; G06T 3/40; G06Q 30/0276
USPC 705/14.72; 382/218

(57) ABSTRACT

An approach is provided in which an image generation system retrieves a set of street view images that were each taken concurrently from a different direction angle at a single geographical location. The image generation system identifies one or more of the street view images depicting points of interest corresponding point of interest preferences. In turn, the image generation system generates a set of thumbnail images corresponding to the set of street view images and point of interest indicators that indicate which of the set of thumbnail images correspond to the street view images depicting the points of interest.

### BACKGROUND

The present disclosure relates to a directional filmstrip display in a street view. More particularly, the present disclosure relates to providing a set of thumbnail images, corresponding to a set of street view images, in an image filmstrip that indicates points of interest depicted in the corresponding street view images.

Mapping technologies include street view images that provide a user with the ability to view a geographical location from a “street view” perspective. The street view images may be taken by, for example, a vehicle-mounted camera that captures images as the vehicle drives along a street. At each geographical location, multiple images corresponding to multiple direction angles may be taken to capture a 360 degree view. For example, a vehicle-mounted camera may utilizes eight different lenses that capture eight different street view images at direction angle increments of 45 degrees (45 degrees, 90 degrees, 135 degrees, and etcetera) from a specific geographical location.

### BRIEF SUMMARY

According to one embodiment of the present disclosure, an approach is provided in which an image generation system retrieves a set of street view images that were each taken concurrently from a different direction angle at a single geographical location. The image generation system identifies one or more of the street view images depicting points of interest corresponding point of interest preferences. In turn, the image generation system generates a set of thumbnail images corresponding to the set of street view images and point of interest indicators that indicate which of the set of thumbnail images correspond to the street view images depicting the points of interest.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a diagram showing an image generation system generating a set of thumbnail images corresponding to a set of street view images and point of interest indicators that indicate which of the set of thumbnail images correspond to street view images depicting points of interest;

FIG. 2 depicts an image capture device that concurrently captures multiple street view images taken from different direction angles;

FIG. 3 shows an embodiment of a display displaying an image filmstrip with point if interest indicators along with a composite image that includes highlight overlays and advertisement overlays;

FIG. 4 shows an embodiment of a user preferences window that allows a user to configure various user preferences;

FIG. 5 is a high-level flowchart showing steps taken in providing an image filmstrip that includes point of interest indicators;

FIG. 6 is a flowchart showing steps taken in identifying points of interests depicted in street view images and creating thumbnail images corresponding to the street view images;

FIG. 7 is a block diagram of a data processing system in which the methods described herein can be implemented; and

FIG. 8 provides an extension of the information handling system environment shown in FIG. 7 to illustrate that the methods described herein can be performed on a wide variety of information handling systems which operate in a networked environment.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The following detailed description will generally follow the summary of the disclosure, as set forth above, further explaining and expanding the definitions of the various aspects and embodiments of the disclosure as necessary.

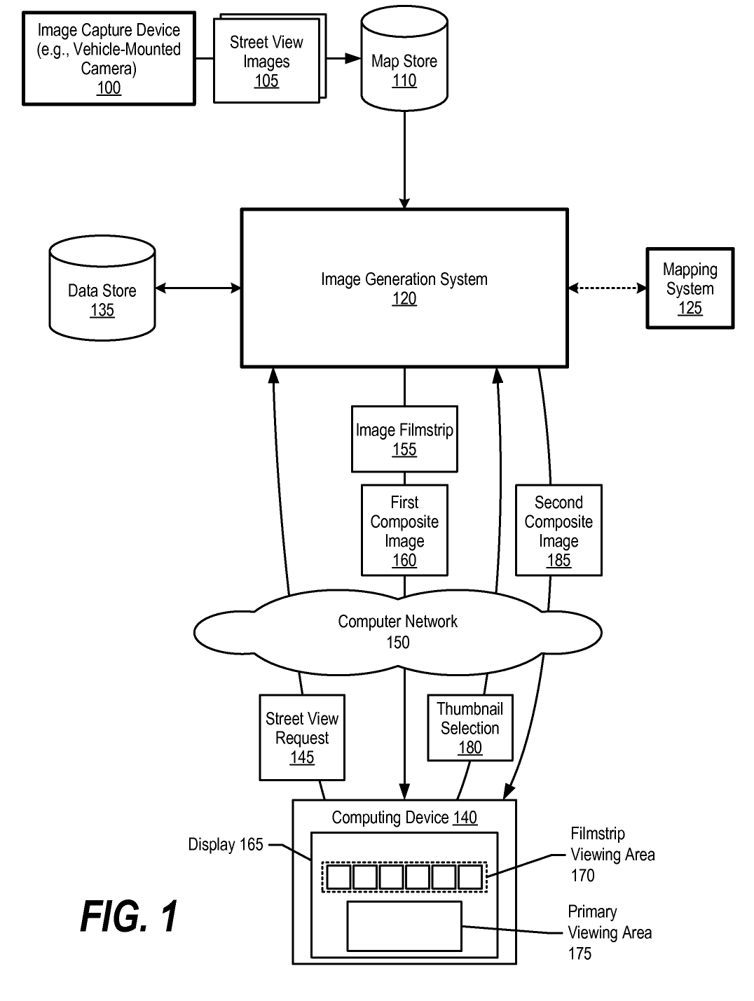

FIG. 1 is a diagram showing an image generation system generating a set of thumbnail images corresponding to a set of street view images and point of interest indicators that indicate which of the set of thumbnail images correspond to the identified street view images depicting the points of interest.

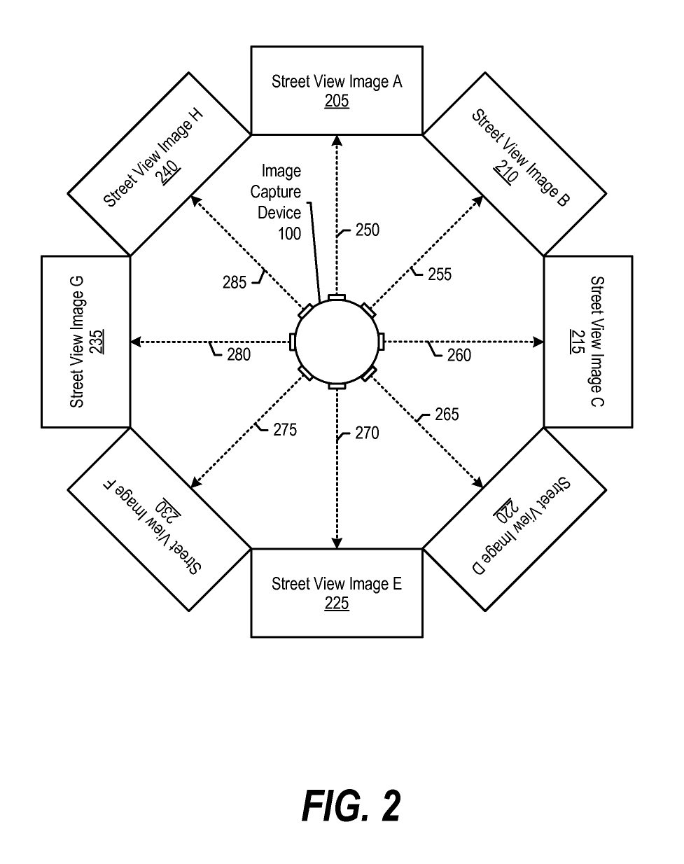

Image capture device 100 captures street view images 105, which are stored in map store 110. For example, a vehicle-mounted camera may capture still images as the vehicle travels on a street. Each of street view images 105 are captured from a street view perspective (e.g., ground level) and include a “geographical location” component (e.g., latitude and longitude, an address, etc.) and a “direction angle” component (e.g., facing East, West, 245 degrees, etc., see FIG. 2 and corresponding text for further details).

Image generation system 120 receives street view request 145 from computing device 140 over computer network 150. Street view request 145 includes a geographical location and a direction angle that is based upon, for example, a user's selection on an electronically displayed map. As such, image generation system 120 retrieves a set of street view images from map store 110 corresponding to the geographical location.

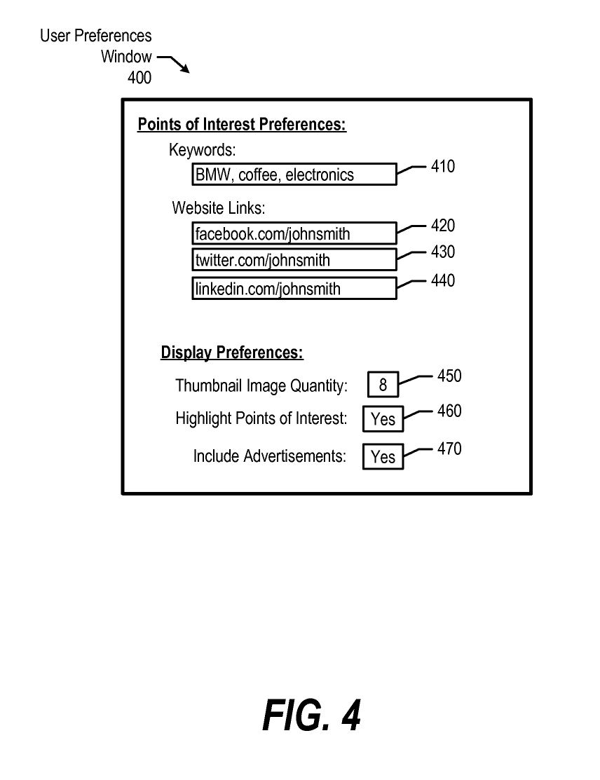

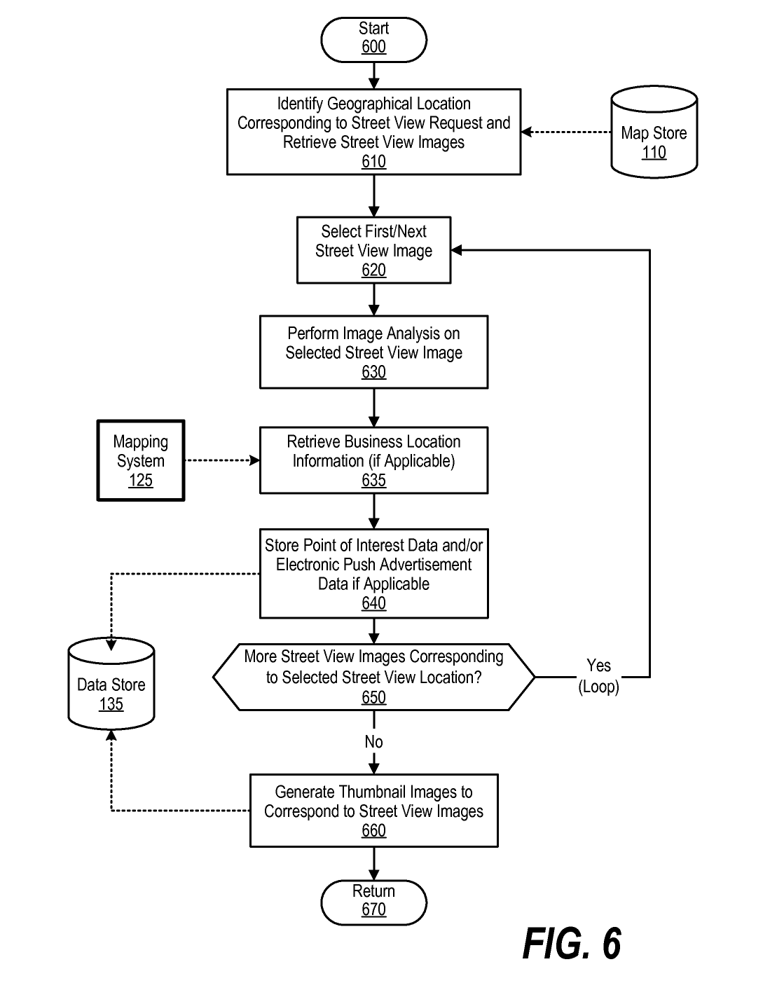

Image generation system 120 identifies a user's point of interest preferences, such as by accessing the user's social network site and/or keywords entered in a user preferences window (see FIGS. 4, 6, and corresponding text for further details). In turn, image generation system 120 determines whether points of interest corresponding to the point of interest preferences are depicted in any of the street view images included in the set of street view images. When image generation system 120 identifies a depicted point of interest, image generation system 120 generates point of interest data that indicates which of the set of street view images include depicted points of interest.

Image generation system 120 generates a set of thumbnail images corresponding to the set of street view images and also generates point of interest indicators based upon the point of interest data generated above. In one embodiment, the point of interest indicators may, for example, highlight the thumbnail images corresponding to street view images depicting points of interest. In another embodiment, the point of interest indicators may be indicators such as a star, an arrow, etc., that indicate which of the thumbnail images correspond to the street view images depicting points of interest.

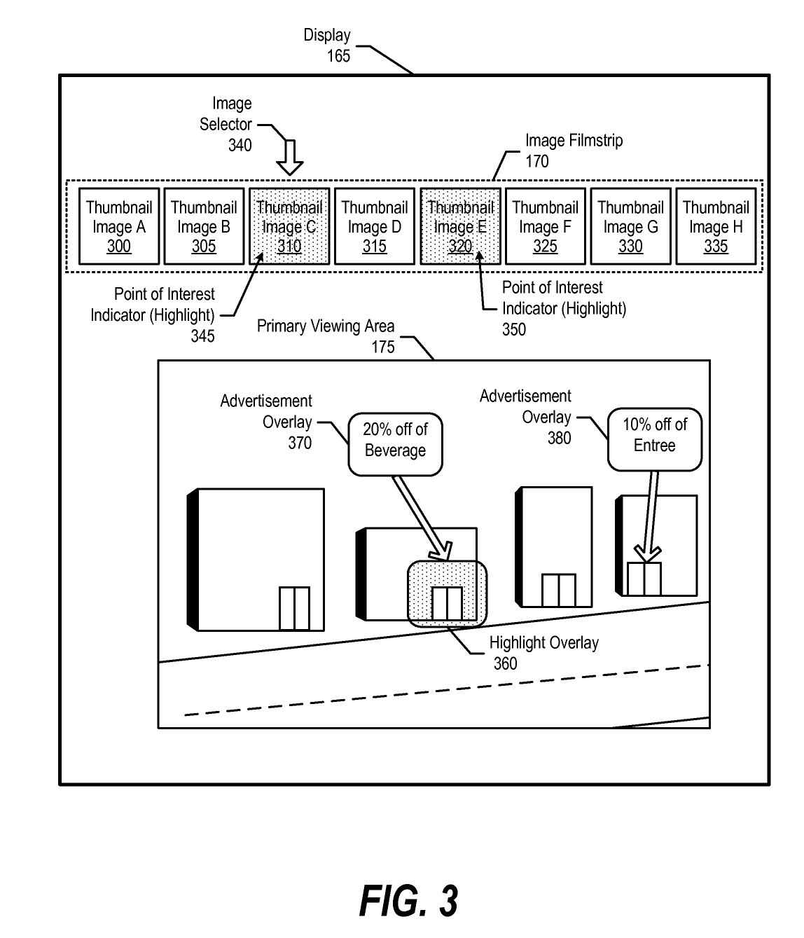

Image generation system 120 includes the set of thumbnail images and the point of interest indicators into an image filmstrip (image filmstrip 155), and sends image filmstrip 155 to computing device 140. Image generation system 120 also generates first composite image 160, which includes a street view image corresponding to the direction angle included in street view request 145 (e.g., North) and may also include highlight overlays that highlight points of interest depicted on the street view image. In one embodiment, first composite image may also include advertisement overlays corresponding to businesses depicted on the street view image (see FIG. 3 and corresponding text for further details).

Computing device 140 displays, on display 165, image filmstrip 155 in filmstrip viewing area 170 and displays first composite image 160 in primary viewing area 175. Computing device 140 receives a user selection that selects one of the thumbnail images included in image filmstrip 155 and, in turn, sends thumbnail selection 180 to image generation system 120. Image generation system 120 retrieves the street view image corresponding to the thumbnail selection and determines whether a point of interest is depicted on the retrieved street view image. If so, image generation system generates highlight overlays that identify the depicted points of interest. In one embodiment, image generation system 120 generates advertisement overlays corresponding to electronic push advertisements from businesses depicted in the street view image.

Image generation system 120 combines the street view image, the highlight overlays, and the advertisement overlays (if applicable) into second composite image 185 and sends second composite image 185 to computing device 140. In turn, computing device displays second composite image 185 in primary viewing area 175. In one embodiment, computing device 140 may move an image selector icon over the newly selected thumbnail image to indicate which corresponding street view image is displayed in primary viewing area 175 (see FIG. 3 and corresponding text for further details).

FIG. 2 depicts an image capture device that concurrently captures multiple street view images taken from different direction angles. FIG. 2 shows a “top down” representation of image capture device 100, such as a vehicle-mounted camera, that includes multiple lenses to concurrently capture street view images 205-240. Each of street view images 205-240 are taken at different direction angles 250-285. For example, assuming direction angle 250 is facing relative North, street view image 255 faces Northeast, street view image 260 faces East, and etcetera. As such, when image generation system 120 receives a street view request, image generation system 120 generates a set of thumbnail images for the set of street view images 205-240 (taken at a particular geographical location), and combines the thumbnail images into an image filmstrip (see FIG. 3 and corresponding text for further details).

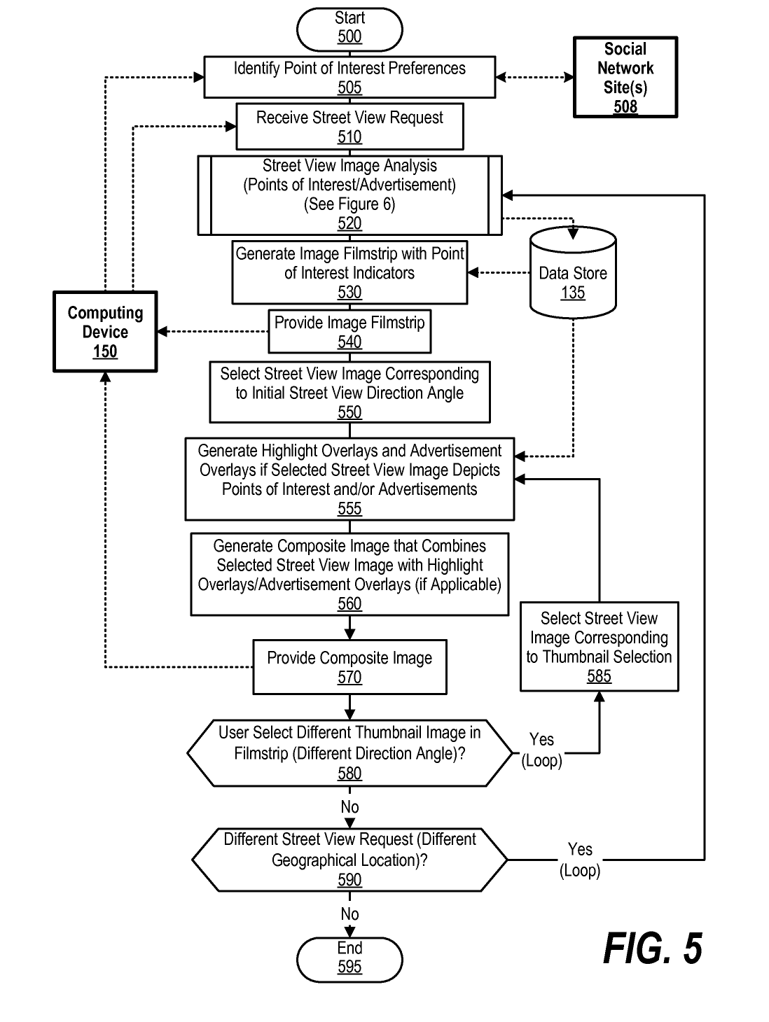

FIG. 3 shows an embodiment of a display displaying an image filmstrip with point if interest indicators along with a composite image that includes highlight overlays and advertisement overlays. Image filmstrip 170 includes thumbnail images 300-335, which correspond to street view images 205-240 shown in FIG. 2. As can be seen, point of interest identifiers 345 and 350 indicate that thumbnail images 310 and 320 correspond to street view images that depict points of interest (see FIGS. 5-6 and corresponding text for further details).

Image selector 340 indicates which corresponding street view image is selected for display in primary viewing area 175. FIG. 3 shows that the selected street view image is combined into a composite image that includes highlight overlay 360, which is overlayed onto the selected street view image to indicate a depicted point of interest. The composite image also includes advertisement overlays 370 and 380, which may be based upon electronic push advertisements generated from businesses depicted in the corresponding street view image. In one embodiment, the advertisements may be filtered based upon the user's points of interest, especially in highly populated metropolitan areas.

FIG. 4 shows an embodiment of a user preferences window that allows a user to configure various user preferences. User preferences window 400 includes an area to configure point of interest preferences (boxes 410-440) and an area to configure display preferences (boxes 450-470). A user may enter keywords in box 410 to indicate points of interests, which image generation system 120 uses to identify points of interests depicted in street view images (e.g., coffee shops). A user may enter network links in boxes 420-440 that point to, for example, the user's social network sites. In turn, image generation system 120 accesses the network links to identify the user's point of interest preferences. For example, the user's social network site may indicate that the user rides motorcycles and, in this example, image generation system 120 may highlight motorcycle stores depicted in street view images.

Regarding display preferences, the user may configure a number of thumbnail images to display in an image filmstrip. For example, instead of viewing eight thumbnail images, the user may prefer to view only four thumbnail images. In this example, the user enters “4” in box 450 and image generation system 120 generates four reformatted street view images from the multiple raw street view images. In turn, image generation system 120 identifies points of interest in the reformatted street view images and generates point of interest indicators and thumbnail images accordingly.

User preferences window 400 also allows the user to select whether image generation system should highlight points of interest (box 460) and whether to highlight advertisements (box 470). In one embodiment, image generation system 120 provides different indicators for points of interest and advertisements. For example, image generation system 120 may highlight thumbnail images in yellow that correspond to points of interest, and may place an advertisement indicator (e.g., a star, arrow, etc.) above thumbnail images that correspond to advertisements.

FIG. 5 is a high-level flowchart showing steps taken in providing an image filmstrip that includes point of interest indicators. Image generation system processing commences at 500, whereupon the image generation system identifies user points of interest preferences (step 505). The image generation system may receive point of interest preferences from a user interface such as that shown in FIG. 4, and/or the image generation system may access a user's social networking sites 508 to determine the user's point of interests.

At step 510, the image generation system receives a street view request from a computing system. The street view request corresponds to a particular geographic location and an initial direction angle (e.g., facing North). The image generation system retrieves a set of street view images taken from multiple direction angles and proceeds through a series of steps to identify points of interest depicted in the set of street view images (pre-defined process block 520, see FIG. 6 and corresponding text for further details). The processing steps include generating point of interest data corresponding to the identified points of interest and generating a set of thumbnail images corresponding to the set of street view images, both of which are stored in data store 135.

At step 530, the image generation system generates an image filmstrip that includes the thumbnail images and point of interest indicators that indicate which of the thumbnail images correspond to street view images depicting a point of interest. The point of interest indicator may be a highlight overlay over a thumbnail image, or the point of interest indicator may be an indicator in proximity to the thumbnail image (e.g., a star above thumbnail images corresponding to points of interest, etc.). The image generation system provides the image filmstrip, which includes the point of interest indicators, to computing device 150 at step 540. In one embodiment, the image generation system waits to provide the image filmstrip until the image generation system creates a composite image corresponding to an initial direction angle (discussed below).

At step 550, the image generation system selects a street view image, from the analyzed street view images, that corresponds to the initial direction angle included in the street view request (e.g., the street view image taken at a “Northern” direction angle). The image generation system, at step 560, identifies points of interest depicted on the selected street view image using point of interest data stored in data store 525 and generates highlight overlays accordingly. For example, the selected street view image may depict a coffee shop that matches the user's point of interest preferences. In one embodiment where the user preferences indicate to display advertisements, the image generation system generates advertisement overlays based upon businesses depicted in the selected street view image.

At step 560, the image generation system generates a composite image by combining the selected street view image with the highlight overlays and advertisement overlays. The image generation system provides the composite image to computing device 150 at step 570, which displays the composite image concurrently with the image filmstrip.

A determination is made as to whether computing device 150 sent a thumbnail selection that selects one of the thumbnail images included in the image filmstrip (decision 580). If the image generation system receives a thumbnail selection, decision 580 branches to the “Yes” branch, which loops back to select a different street view image corresponding to the selected thumbnail image and create highlight overlays/advertisement overlays for the newly selected street view image.

If the image generation system does not receive a thumbnail selection, decision 580 branches to the “No” branch, whereupon a determination is made as to whether the computing device sent a different street view request that corresponds to a different geographical location (e.g., 100 feet away from initial geographical location) (decision 590). If the image generation system receives a different street view request, decision 590 branches to the “Yes” branch, whereupon processing loops back to retrieve a different set of street view images corresponding to a new geographical location included in the different street view request and generate a new image filmstrip and composite image accordingly. This looping continues until image generation processing should terminate, at which point decision 590 branches to the “No” branch and processing ends at 595.

FIG. 6 is a flowchart showing steps taken in identifying points of interests depicted in street view images and creating thumbnail images corresponding to the street view images. Processing commences at 600, whereupon the image generation system retrieves a set of street view images corresponding to a geographical location included in a street view request (step 610).

The image generation system selects one of the street view images at step 620, and performs image analysis on the selected street view image to determine whether the selected street view image depicts points of interest (step 630). For example, if a user has children, then scenes that have playgrounds, amusement parks, etc. may be of interest (e.g., the playgrounds and amusement parks may be identified by equipment such as swings, rides, and/or based on a sign's logo or text recognition. Likewise people interested in fishing may get an indication of potentially interesting scenes depicting a pier, a lake, a bait shop, etc.

In one embodiment, at step 635, the image generation system accesses mapping system 125 to determine whether a range of depicted addresses in the selected street view images correspond with one or more points of interest. For example, the street view image may display businesses from 123 Main Street through 150 Main Street and, in this example, the image generation system may determine whether any businesses corresponding to the range of depicted addresses correspond to the user's point of interest preferences (e.g., a coffee shop located at 125 Main Street).

At step 640, the image generation system stores point of interest data in data store 125 that links identified points of interest to the selected street view image. For example, data store 125 may include a table that includes a field to store a street view image reference number (e.g., image #3) and pixel locations of depicted points of interest (e.g., row 45, column 145, cycle shop).

A determination is made as to whether there are more street view images in the set of street view images to analyze (decision 650). If there are more street view images to analyze, decision 650 branches to the “Yes” branch, which loops back to select and analyze the next street view image. This looping continues until there are no more street view images to analyze in the retrieved set of street view images, at which point decision 650 branches to the “No” branch, whereupon the image generation system generates thumbnail images based upon the set of street view images at step 660. Processing returns at 670.

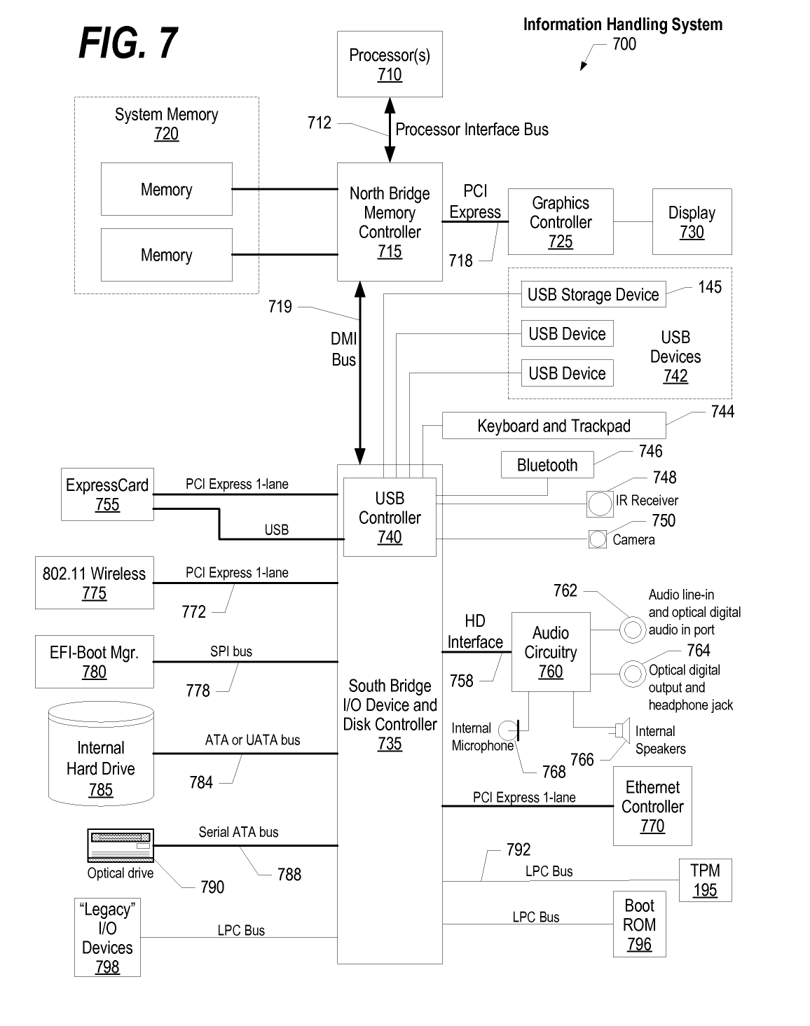

FIG. 7 illustrates information handling system 700, which is a simplified example of a computer system capable of performing the computing operations described herein. Information handling system 700 includes one or more processors 710 coupled to processor interface bus 712. Processor interface bus 712 connects processors 710 to Northbridge 715, which is also known as the Memory Controller Hub (MCH). Northbridge 715 connects to system memory 720 and provides a means for processor(s) 710 to access the system memory. Graphics controller 725 also connects to Northbridge 715. In one embodiment, PCI Express bus 718 connects Northbridge 715 to graphics controller 725. Graphics controller 725 connects to display device 730, such as a computer monitor.

Northbridge 715 and Southbridge 735 connect to each other using bus 719. In one embodiment, the bus is a Direct Media Interface (DMI) bus that transfers data at high speeds in each direction between Northbridge 715 and Southbridge 735. In another embodiment, a Peripheral Component Interconnect (PCI) bus connects the Northbridge and the Southbridge. Southbridge 735, also known as the I/O Controller Hub (ICH) is a chip that generally implements capabilities that operate at slower speeds than the capabilities provided by the Northbridge. Southbridge 735 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 796 and “legacy” I/O devices (using a “super I/O” chip). The “legacy” I/O devices (798) can include, for example, serial and parallel ports, keyboard, mouse, and/or a floppy disk controller. The LPC bus also connects Southbridge 735 to Trusted Platform Module (TPM) 795. Other components often included in Southbridge 735 include a Direct Memory Access (DMA) controller, a Programmable Interrupt Controller (PIC), and a storage device controller, which connects Southbridge 735 to nonvolatile storage device 785, such as a hard disk drive, using bus 784.

ExpressCard 755 is a slot that connects hot-pluggable devices to the information handling system. ExpressCard 755 supports both PCI Express and USB connectivity as it connects to Southbridge 735 using both the Universal Serial Bus (USB) the PCI Express bus. Southbridge 735 includes USB Controller 740 that provides USB connectivity to devices that connect to the USB. These devices include webcam (camera) 750, infrared (IR) receiver 748, keyboard and trackpad 744, and Bluetooth device 746, which provides for wireless personal area networks (PANs). USB Controller 740 also provides USB connectivity to other miscellaneous USB connected devices 742, such as a mouse, removable nonvolatile storage device 745, modems, network cards, ISDN connectors, fax, printers, USB hubs, and many other types of USB connected devices. While removable nonvolatile storage device 745 is shown as a USB-connected device, removable nonvolatile storage device 745 could be connected using a different interface, such as a Firewire interface, etcetera.

Wireless Local Area Network (LAN) device 775 connects to Southbridge 735 via the PCI or PCI Express bus 772. LAN device 775 typically implements one of the IEEE 802.11 standards of over-the-air modulation techniques that all use the same protocol to wireless communicate between information handling system 700 and another computer system or device. Optical storage device 790 connects to Southbridge 735 using Serial ATA (SATA) bus 788. Serial ATA adapters and devices communicate over a high-speed serial link. The Serial ATA bus also connects Southbridge 735 to other forms of storage devices, such as hard disk drives. Audio circuitry 760, such as a sound card, connects to Southbridge 735 via bus 758. Audio circuitry 760 also provides functionality such as audio line-in and optical digital audio in port 762, optical digital output and headphone jack 764, internal speakers 766, and internal microphone 768. Ethernet controller 770 connects to Southbridge 735 using a bus, such as the PCI or PCI Express bus. Ethernet controller 770 connects information handling system 700 to a computer network, such as a Local Area Network (LAN), the Internet, and other public and private computer networks.

While FIG. 7 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

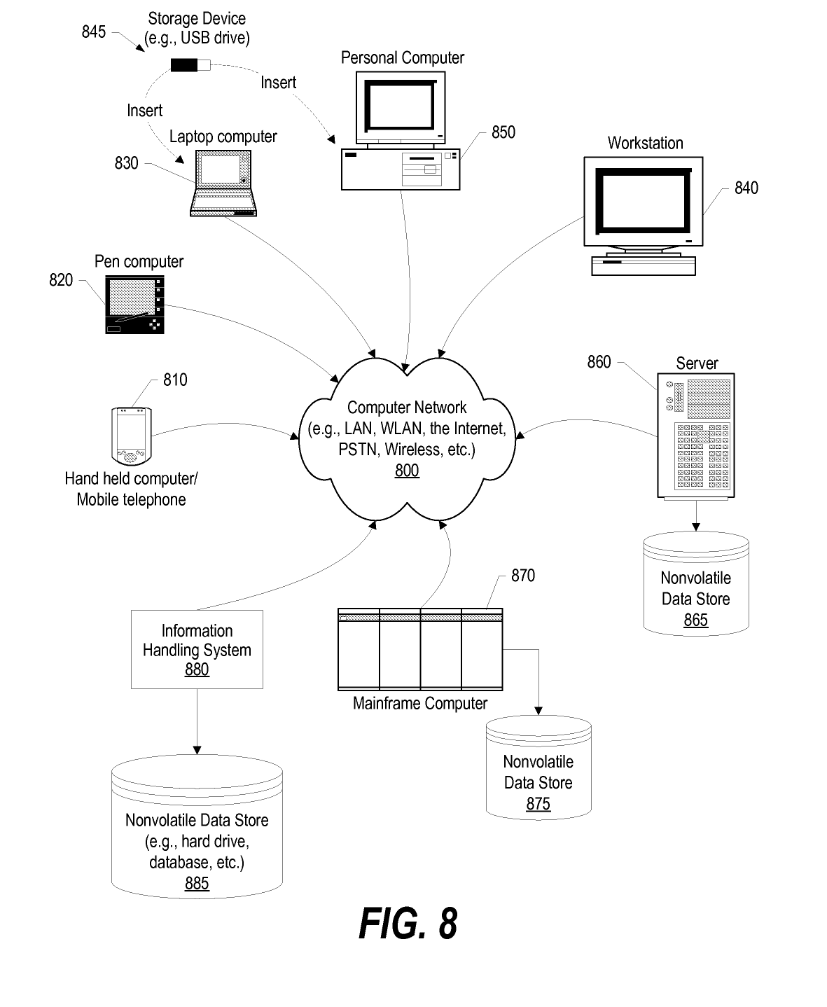

The Trusted Platform Module (TPM 795) shown in FIG. 7 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 8.

FIG. 8 provides an extension of the information handling system environment shown in FIG. 7 to illustrate that the methods described herein can be performed on a wide variety of information handling systems that operate in a networked environment. Types of information handling systems range from small handheld devices, such as handheld computer/mobile telephone 810 to large mainframe systems, such as mainframe computer 870. Examples of handheld computer 810 include personal digital assistants (PDAs), personal entertainment devices, such as MP3 players, portable televisions, and compact disc players. Other examples of information handling systems include pen, or tablet, computer 820, laptop, or notebook, computer 830, workstation 840, personal computer system 850, and server 860. Other types of information handling systems that are not individually shown in FIG. 8 are represented by information handling system 880. As shown, the various information handling systems can be networked together using computer network 800. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 8 depicts separate nonvolatile data stores (server 860 utilizes nonvolatile data store 865, mainframe computer 870 utilizes nonvolatile data store 875, and information handling system 880 utilizes nonvolatile data store 885). The nonvolatile data store can be a component that is external to the various information handling systems or can be internal to one of the information handling systems. In addition, removable nonvolatile storage device 745 can be shared among two or more information handling systems using various techniques, such as connecting the removable nonvolatile storage device 745 to a USB port or other connector of the information handling systems.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method comprising:
generating a plurality of thumbnail images corresponding to a plurality of street view images, wherein each of the plurality of street view images were captured concurrently at a single geographical location and taken from a different one of a plurality of direction angles;
identifying one or more of the plurality of street view images that depict at least one point of interest based upon one or more point of interest preferences; and
generating one or more point of interest indicators that indicate which of the plurality of thumbnail images correspond to the identified one or more street view images.

2. The method of claim 1 further comprising:
including the plurality of thumbnail images and the one or more point of interest indicators in an image filmstrip;
sending the image filmstrip over a computer network to a computing system;
receiving a thumbnail selection from the computing system that selects one of the plurality of thumbnail images corresponding to one of the point of interest indicators included in the image filmstrip;
selecting one of the plurality of street view images that correspond to the selected thumbnail image;
generating a composite image the combines the selected street view image with a highlight overlay that identifies the point of interest depicted in the selected street view image; and
providing the composite image to the computing system.

3. The method of claim 2 further comprising:
determining that the selected street view image depicts one or more business locations corresponding to one or more electronic push advertisements;
generating one or more advertisement overlays that correspond to the one or more electronic push advertisements; and
combining the one or more advertisement overlays with the street view image and the highlight overlay.

4. The method of claim 1 wherein the identification further comprises:
selecting one of the plurality of street view images;
performing image analysis on the selected street view image;
determining, based upon the image analysis, that the selected street view image depicts at least one of the points of interest; and
generating at least one of the point of interest indicators in response to determining that at least one of the points of interest is depicted in the selected street view image.

5. The method of claim 1 wherein the identification further comprises:
selecting one of the plurality of street view images;
determining a range of depicted street addresses corresponding to the selected street view image; and
accessing a mapping system to determine whether the range of depicted street addresses correspond to one or more points of interest based upon the point of interest preferences.

6. The method of claim 1 further comprising:
retrieving one or more social network profiles; and
generating the one or more point of interest preferences based upon the retrieved one or more social network profiles.

7. The method of claim 1 further comprising:
receiving a thumbnail image quantity preference;
formatting the plurality of street view images based upon the thumbnail image quantity preference, the formatting resulting in a plurality of formatted street view images, wherein a number of the formatted street view images included in the plurality of formatted street view images equals the thumbnail image quantity preference; and
generating a plurality of different thumbnail images based upon the formatted plurality of street view images, wherein a number of the different thumbnail images included in the plurality of different thumbnail images equals the thumbnail image quantity preference.

8. An information handling system comprising:
one or more processors;
a memory coupled to at least one of the processors;
a set of computer program instructions stored in the memory and executed by at least one of the processors in order to perform actions of:
generating a plurality of thumbnail images corresponding to a plurality of street view images, wherein each of the plurality of street view images were captured concurrently at a single geographical location and taken from a different one of a plurality of direction angles;
identifying one or more of the plurality of street view images that depict at least one point of interest based upon one or more point of interest preferences; and
generating one or more point of interest indicators that indicate which of the plurality of thumbnail images correspond to the identified one or more street view images.

9. The information handling system of claim 8 wherein the set of computer program instructions, when executed by at least one of the processors, performs additional actions comprising:
including the plurality of thumbnail images and the one or more point of interest indicators in an image filmstrip;
sending the image filmstrip over a computer network to a computing system;
receiving a thumbnail selection from the computing system that selects one of the plurality of thumbnail images corresponding to one of the point of interest indicators included in the image filmstrip;
selecting one of the plurality of street view images that correspond to the selected thumbnail image;
generating a composite image the combines the selected street view image with a highlight overlay that identifies the point of interest depicted in the selected street view image; and
providing the composite image to the computing system.

10. The information handling system of claim 9 wherein the set of computer program instructions, when executed by at least one of the processors, performs additional actions comprising:
determining that the selected street view image depicts one or more business locations corresponding to one or more electronic push advertisements;
generating one or more advertisement overlays that correspond to the one or more electronic push advertisements; and
combining the one or more advertisement overlays with the street view image and the highlight overlay.

11. The information handling system of claim 8 wherein the set of computer program instructions, when executed by at least one of the processors, performs additional actions comprising:
selecting one of the plurality of street view images;
performing image analysis on the selected street view image;
determining, based upon the image analysis, that the selected street view image depicts at least one of the points of interest; and
generating at least one of the point of interest indicators in response to determining that at least one of the points of interest is depicted in the selected street view image.

12. The information handling system of claim 8 wherein the set of computer program instructions, when executed by at least one of the processors, performs additional actions comprising:
selecting one of the plurality of street view images;
determining a range of depicted street addresses corresponding to the selected street view image; and
accessing a mapping system to determine whether the range of depicted street addresses correspond to one or more points of interest based upon the point of interest preferences.

13. The information handling system of claim 8 wherein the set of computer program instructions, when executed by at least one of the processors, performs additional actions comprising:
retrieving one or more social network profiles; and
generating the one or more point of interest preferences based upon the retrieved one or more social network profiles.

14. The information handling system of claim 8 wherein the set of computer program instructions, when executed by at least one of the processors, performs additional actions comprising:
receiving a thumbnail image quantity preference;
formatting the plurality of street view images based upon the thumbnail image quantity preference, the formatting resulting in a plurality of formatted street view images, wherein a number of the formatted street view images included in the plurality of formatted street view images equals the thumbnail image quantity preference; and
generating a plurality of different thumbnail images based upon the formatted plurality of street view images, wherein a number of the different thumbnail images included in the plurality of different thumbnail images equals the thumbnail image quantity preference.

15. A computer program product stored in a computer readable storage medium, comprising computer program code that, when executed by an information handling system, causes the information handling system to perform actions comprising:
generating a plurality of thumbnail images corresponding to a plurality of street view images, wherein each of the plurality of street view images were captured concurrently at a single geographical location and taken from a different one of a plurality of direction angles;
identifying one or more of the plurality of street view images that depict at least one point of interest based upon one or more point of interest preferences; and
generating one or more point of interest indicators that indicate which of the plurality of thumbnail images correspond to the identified one or more street view images.

16. The computer program product of claim 15 wherein the computer program code, when executed by the information handling system, causes the information handling system to perform additional actions comprising:
including the plurality of thumbnail images and the one or more point of interest indicators in an image filmstrip;
sending the image filmstrip over a computer network to a computing system;
receiving a thumbnail selection from the computing system that selects one of the plurality of thumbnail images corresponding to one of the point of interest indicators included in the image filmstrip;
selecting one of the plurality of street view images that correspond to the selected thumbnail image;
generating a composite image the combines the selected street view image with a highlight overlay that identifies the point of interest depicted in the selected street view image; and
providing the composite image to the computing system.

17. The computer program product of claim 16 wherein the computer program code, when executed by the information handling system, causes the information handling system to perform additional actions comprising:
determining that the selected street view image depicts one or more business locations corresponding to one or more electronic push advertisements;
generating one or more advertisement overlays that correspond to the one or more electronic push advertisements; and
combining the one or more advertisement overlays with the street view image and the highlight overlay.

18. The computer program product of claim 15 wherein the computer program code, when executed by the information handling system, causes the information handling system to perform additional actions comprising:
selecting one of the plurality of street view images;
performing image analysis on the selected street view image;
determining, based upon the image analysis, that the selected street view image depicts at least one of the points of interest; and
generating at least one of the point of interest indicators in response to determining that at least one of the points of interest is depicted in the selected street view image.

19. The computer program product of claim 15 wherein the computer program code, when executed by the information handling system, causes the information handling system to perform additional actions comprising:
selecting one of the plurality of street view images;
determining a range of depicted street addresses corresponding to the selected street view image; and
accessing a mapping system to determine whether the range of depicted street addresses correspond to one or more points of interest based upon the point of interest preferences.

20. The computer program product of claim 15 wherein the computer program code, when executed by the information handling system, causes the information handling system to perform additional actions comprising:
retrieving one or more social network profiles; and
generating the one or more point of interest preferences based upon the retrieved one or more social network profiles.
